(19) United States
(12) Patent Application Publication
(10) Pub. No.: US 2007/0155556 A1
(43) Pub. Date: Jul. 5, 2007

(54) Tensioning arrangement

(76) Inventors: Hans-Rudolf Jenni, Grasswill (CH); Joerg Grebert, Ransbach-Baumbach (DE)

Correspondence Address: SHLESINGER, ARKWRIGHT & GARVEY LLP, Suite 600, 1420 King Street, Alexandria, VA, 22314, US

(21) Appl. No.: 11/600,908

(22) Filed: Nov. 17, 2006

(30) Foreign Application Priority Data
Nov. 17, 2005 (DE) 10 2005 056 506.9

(51) Int. Cl. F16H 7/08

(52) U.S. Cl. 474/111

(57) ABSTRACT

The tensioning arrangement according to the invention is intended for tensioning a chain (6) in a control assembly (2) and comprises at least one tensioning rail (10) and at least one other slide rail (8), the minimum of one other slide rail (8) being constructed so as to deform, depending on the temperature, such that it counteracts thermally produced tolerance in the control assembly (2).

The invention relates to a tensioning arrangement, a control assembly, a slide rail and an engine.

Engines or internal combustion engines are exposed to great temperature differences over their range of use, starting from a cold start to temperatures above their designed temperature under high load, particularly if there is insufficient cooling. Temperature differences of this kind lead to thermal expansion in components of the engine. This affects in particular a control assembly provided for driving camshafts of the engine, the control assembly having a drive member which loops around wheels mounted on shafts of the engine. Since the control assembly is normally of considerable length, correspondingly great differences in length may occur within the control assembly under the effect of temperature variations.

Against this background, a tensioning arrangement is proposed having the features of claim 1, a control assembly having the features of claim 6, an engine having the features of claim 8 and a slide rail having the features of claim 12.

The tensioning arrangement according to the invention is designed to tension a chain in a control assembly and has at least one tensioning rail and at least one other slide rail, the minimum of one other slide rail being designed so as to deform as a function of the temperature such that it counteracts a thermally produced tolerance in the control assembly.

The minimum of one tensioning rail in the tensioning arrangement is normally designed to equalise tolerances in the control assembly and can cooperate with a tensioning element. The minimum of one other slide rail is designed to assist the minimum of one tensioning rail. The minimum of one other slide rail may be constructed as a slide rail according to the invention, described hereinafter.

The purpose of the tensioning rail, which typically cooperates with a tensioning element, is to compensate tolerances, e.g. temperature- and/or wear-induced expansion in the control assembly or in a chain assembly. Such tolerances are caused for example by the cooperation of the chain with the engine and become apparent particularly when the chain and the engine are made of different materials.

The further apart in the engine are the shafts which are to be connected and hence the wheels which cooperate with the chain, and hence the longer the chain, the greater the need for changes in geometry obtained by means of the tensioning arrangement. The minimum of one tensioning rail cooperating with the tensioning element must be designed so that it provides a correspondingly long adjustment distance along which the chain is to be deflected. In this case the room taken up by the tensioning rail and tensioning element is greater, which may lead to considerable space problems in compact engines which have to accommodate the minimum of one tensioning rail with tensioning element.

Consequently, the minimum of one further slide rail is provided in the control assembly as an additional component of the tensioning arrangement. By virtue of its inherent thermal expansion it assists the function of at least one adjusting element which comprises the minimum of one tensioning rail and the tensioning element, and thus reduces the need for a change in geometry. As a result, relatively small, standard tensioning rails and tensioning elements can be used, which are easy to accommodate in the control assembly and in the engine.

The minimum of one other tensioning rail is preferably made in one piece or consists of only one module. It may be fixedly mounted in the control assembly so that, unlike the minimum of one tensioning rail, it does not perform any relative movements. The minimum of one slide rail compensates only some of the tolerances occurring within the control drive.

The control assembly according to the invention cooperates with an engine and has a chain, a number of wheels and the tensioning arrangement according to the invention.

Wheels of the control assembly are attached to shafts of the engine, which are largely mounted in a housing of the engine. The chain or any other suitable drive member, e.g. a belt or V-belt, is made of steel, in particular, and cooperates with the wheels and hence with the shafts of the engine. Preferably the chain wraps around at least two of these wheels, so that forces and/or rotary movements can be transmitted via the chain between the wheels and hence the shafts.

The engine according to the invention has a housing and a number of shafts. The shafts are at least partly mounted in the housing. In addition, the engine has a chain which cooperates with at least two of the shafts. This engine also comprises the tensioning arrangement according to the invention.

At least one of the shafts of the engine may be designed to drive a camshaft. It is envisaged that the housing of the engine is formed largely of aluminium, whereas the chain or other suitable drive member is formed largely of steel.

The engine has at least two wheels mounted on shafts. At least one slide rail according to the invention, which will be described hereinafter, is attached to a housing of the engine.

The slide rail according to the invention for a control assembly of an engine is designed to deform, as a function of the temperature, so as to counteract thermally produced tolerances in the control assembly.

This slide rail is to be mounted fixedly relative to the control assembly and by virtue of its construction is self-deforming under the effect of temperature such that it counteracts the thermally produced tolerance, particularly a difference in length, which may occur as a result of different material and/or thermal properties of the engine and of a chain of the control assembly.

The slide rail according to the invention for the control assembly may have a sliding surface and is to be attached regularly to an engine by means of at least one attachment point such that the chain of the engine is arranged between the sliding surface and the minimum of one attachment point, so that the drive member acted upon by the sliding surface can be tensioned depending on the temperature.

The slide rail may generally also be constructed so as to deflect a drive member other than a chain, e.g. for deflecting a belt or V-belt.

The slide rail is attached to a housing of the engine via the minimum of one attachment point. This engine or a corresponding internal combustion engine has a number of shafts which are at least partly mounted in the housing. The control assembly comprises a number of wheels or guide wheels arranged on the shafts, the centres of the wheels being mounted on the shafts, while the chain cooperates with these wheels. This may mean that the chain loops around the wheels, so that rotary movements and/or forces can be transmitted between individual wheels and hence between individual shafts of the engine.

Moreover, it is preferable for the chain to be made of steel or a metal alloy, largely containing iron. The housing of the engine, on the other hand, is normally made of aluminium or cast aluminium or a corresponding metal compound or alloy largely containing aluminium.

As the housing for accommodating the shafts and the chain which cooperates with the shafts via the wheels are made of different metallic materials with different thermal expansion coefficients, it happens that during the operation of the engine thermally produced differences in length occur in the control assembly which are caused by an expansion of the chain and by distances between the shafts in the housing which vary to different extents as a result of heat and hence between the wheels around which the chain is looped.

In a preferred embodiment of the chain made of steel, on the one hand, and the engine housing made of aluminium, on the other hand, it is found that during operation of the engine the housing expands more than the chain as the temperature increases. The result of this is that the chain noticeably shortens within the control assembly relative to a spacing between individual wheels of the control assembly. A material for the slide rail and particularly for the section of the slide rail must be selected in accordance with the different expansion coefficients which apply to the chain and to the engine housing.

The slide rail according to the invention, which is also referred to as a so-called chain rail, is to be fixedly mounted to the engine via the minimum of one attachment point. By virtue of its geometry, the material characteristics, thermal expansion and/or a position in which the slide rail is arranged within the control assembly and on the engine, the slide rail is able to deform as the temperature varies such that the slide rail counteracts thermally produced differences in length within the control assembly.

In the slide rail, the sliding surface or any other operating element acting on the chain and the minimum of one attachment point are joined together by means of a section which expands as the temperature increases, or a corresponding member of the slide rail, which thus extends between the sliding surface and the minimum of one attachment point. The result of this is that a spacing between the operating element and the minimum of one attachment point increases as the temperature rises and decreases as the temperature falls. As the chain is arranged between the sliding surface and the minimum of one attachment point, the chain is deflected or tensioned by the slide rail by an adjustment distance s dependent on the temperature T, the value for the adjustment distance s, at least in a temperature range prevailing in the engine between a cold start and maximum speed, decreasing as the temperature rises and increasing as the temperature falls. Deflection of the chain by the adjustment distance s means that a track along which the chain travels in the control assembly is deflected by a distance corresponding to the adjustment distance s.

The sliding surface may be convex. An operating element which is an alternative to the sliding surface may be constructed as a roller acting on the chain, in which case a spindle for receiving the roller is connected with the minimum of one attachment point as a component of the section or via the section. It is envisaged that the chain will slide along the sliding surface. The sliding surface may have a suitable coating so that only low friction is generated between the sliding surface and the chain during operation of the engine.

The slide rail is preferably substantially in one piece, so that the section and the operating surface form a unit. Because of the one-piece construction the secured slide rail in the control assembly performs no relative or pivoting movements relative to the chain, as would be the case with tensioning rails pivoted by tensioning element. The slide rail is designed to deform thermally, while the sliding surface moves relative to the minimum of one attachment point.

At least one attachment means for the slide rail, which is to be associated with the minimum of one attachment point, may be constructed as a component of the section. The minimum of one attachment means is constructed for example as an opening and hence the slide rail is to be secured to the minimum of one attachment point via at least one attachment element, e.g. a screw or a bolt which passes through this opening.

The slide rail is to be attached regularly to the engine in such a way that the minimum of one attachment point is preferably arranged on a convex side of the chain. Action on the chain or tensioning of the chain by the sliding surface may take place in a direction oriented towards the minimum of one attachment point.

The slide rail may be attached to the engine such that the chain is acted upon along the track of the chain between two wheels rotating in the same direction about their shafts. Moreover, the slide rail may be attached to the engine such that an area of the sliding surface acting upon the chain is oriented into the interior of a surface which is surrounded by the chain, so that the sliding surface can tension the chain inwardly. An alternative arrangement in which the sliding surface tensions the chain outwards is also possible and in this arrangement, too, the chain is less strongly tensioned by the slide rail as the temperature increases.

In the chain or a control chain, wear-induced expansion may also occur. The additional differences in length occurring in the control assembly as a result can be compensated by the tensioning rail. The temperature-induced differences in length can be compensated by the slide rail such that correct pretensioning of the chain is obtained in all operational situations of the engine or control assembly, even after long operational periods.

It is envisaged that by virtue of its own thermal expansion the slide rail supports or assists a function of a conventional adjusting element which comprises a tensioning rail cooperating with a tensioning element, or reduces the need for deflection of the chain which is to be provided by this adjusting element. Thus, relatively small, standard tensioning rails and tensioning elements can be used which are easily accommodated in control assemblies.

Other advantages and embodiments of the invention will become apparent from the description and the attached drawings.

It will be understood that the features mentioned above and those to be described hereinafter can be used not only in the particular combinations stated but also in other combinations or on their own without departing from the scope of the present invention.

The invention is schematically illustrated in the drawings by reference to an exemplifying embodiment and is described in more detail hereinafter with reference to the drawings.

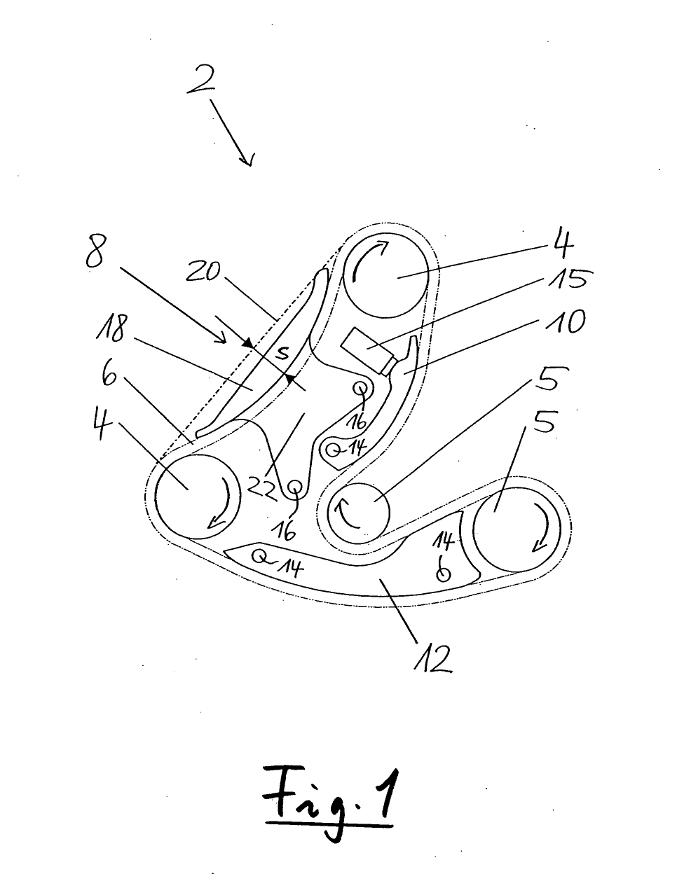

FIG. 1 is a schematic view of a preferred embodiment of a control assembly.

The control assembly 2 diagrammatically shown in FIG. 1, in a preferred embodiment, comprises four wheels 4, 5 which rotate clockwise in operation. These wheels 4, 5 are attached to shafts of an engine, not shown in detail here, the shafts being rotatably mounted in a housing of the engine. Cooperating with the wheels 4, 5 is a drive member constructed as a chain 6.

As differences in length occur in the control assembly 2 as a result of temperature influences on the engine, and as the chain 6 is additionally subject to wear-induced expansion over its service life, the control assembly 2 comprises a tensioning rail 10 and a further slide rail 8 and a guide rail 12. The tensioning rail 10 causes the chain 6 to be deflected laterally, thereby compensating for a variation in the length of the chain 6 and hence a resulting expansion within the control assembly 2. The tensioning rail 10 and the guide rail 12 are attached to the engine via attachment points 14. The tensioning rail 10 cooperates with a hydraulic tensioning element 15 by means of which the action of the tensioning rail 10 on the chain 6 is to be regulated. Alternatively, the tensioning rail 10 may cooperate with a spring instead of the hydraulic tensioning element 15.

The tensioning rail 10 with the tensioning element 15 and the guide rail 12 shown in FIG. 1 are also used in conventional control assemblies for suitably tensioning drive members and improving their running characteristics.

The slide rail 8 which is also provided in the present control assembly 2 is mounted on the engine by means of attachment points 16. A domed sliding surface 18 serves here as an operating element of the slide rail 8. This domed sliding surface 18 is constructed so as to act upon the chain 6 in the direction of a surface enclosed by the chain 6. The chain 6 is arranged between the domed sliding surface 18 and the two attachment points 16 of the slide rail 8, and hence the two attachment points 16 are located on a convex side of the chain 6.

When the engine heats up during operation, thermal expansion increases the axial distances between the shafts mounted in components of the engine housing and hence also spacings between the wheels 4, 5 around which the chain 6 is looped.

The chain 6 also expands as the temperature increases. However, as the chain is made of steel and the housing or components of the housing are formed from aluminium, the thermal expansion of the housing as a function of temperature is roughly twice as great as the thermal expansion of the chain 6. As a result a spacing between the wheels 4, 5 increases relatively more than the expansion of the chain 6. This means that the chain 6 appears to shorten within the control assembly 2.

In control assemblies according to the prior art, different thermal expansions of this kind are compensated by a reduced deflection of a [sic] by movable tensioning means which are similar to the tensioning rail 10 with tensioning element 15 shown in FIG. 1.

One problem with conventional control assemblies according to the prior art is that even where space is restricted suitable force conditions have to be secured over a distance by which the drive member has to be tensioned.

The slide rail 8 shown in a preferred embodiment in FIG. 1, which is fixedly mounted as an additional component in the control assembly 2, is designed so that it needs significantly less space in order to provide a temperature-dependent action upon the chain 6 by the operating element, compared with known adjustment elements which comprise tensioning rails 10 and additional tensioning elements 15. For this reason, the slide rail 8 is designed so that its thermal expansion leads to a deformation which counteracts thermally-induced tolerances or differences in length in the control assembly 2.

This slide rail 8, which is fixedly mounted by means of the attachment points 16, is constructed, by virtue of its geometry and material characteristics, such that it deflects the chain 6 out of a track 20 along which the chain 6 runs, to a greater extent at low temperatures than at high temperatures. Thus, when there is a change in temperature, the slide rail 8 causes the length of the chain 6 to change relative to the track 20, to counteract the normal apparent shortening of the chain 6 which occurs on heating. The chain 6 is at the same time deflected by the slide rail 8 by an adjustment distance s.

The slide rail 8 also causes a reduction in the difference in length which has to be compensated by the tensioning rail 10 with the tensioning element 15 on the chain 6. Thus, the tensioning element 15 for the tensioning rail 10 may be made smaller and more compact than is normal. The slide rail 8 is thus able to assist conventional tensioning devices which are normally provided in control assemblies 2 for compensating temperature-induced tolerances.

The attachment points 16 of the slide rail 8 to the housing of the engine are transversely some distance away from the track 20 on the convex side of the chain 6 and a convex side of the domed sliding surface 18. If the slide rail 8 heats up with the engine, expansion of a section 22 of the slide rail 8 between the attachment points 16 and the chain track 20 causes the convex sliding surface 18 to be moved away from the attachment points 16 by the adjustment distance s and thereby reduce the deflection of the chain 6 from the track 20. Consequently, the length of chain 6 required between the two wheels 4 is also reduced, thereby counteracting the apparent shortening of the chain 6 as a result of thermal influences.

The further apart the shafts which are to be movably connected in the engine via the chain 6, and the longer the chain 6, the greater the need for compensatory changes in geometry brought about by the tensioning rails 10 and tensioning element 15. The greater the difference in length which is to be compensated, the greater the space taken up by the tensioning rails 10 and the tensioning element 15. However, precisely in compact engines, this can lead to problems of space. An inherent thermal expansion of the section 22 of the slide rail 8 and of the slide rail 8 as a whole supports the function of the tensioning rail 10 and of the tensioning element 15 in FIG. 1 and reduces the need for changes in geometry. Thus, a relatively small, standard tensioning element 15 can be used, which is easily accommodated in the control assembly 2.

1. Tensioning arrangement which is intended to tension a chain (6) in a control assembly (2) and comprises at least one tensioning rail (10) and at least one additional slide rail (8), the minimum of one additional slide rail (8) being constructed do as to deform as a function of the temperature such that it counteracts a thermally produced tolerance in the control assembly (2).

2. Tensioning arrangement according to claim 1, wherein the minimum of one tensioning rail (10) is constructed so as to compensate for tolerances in the control assembly (2).

3. Tensioning arrangement according to claim 1, wherein the minimum of one tensioning rail (10) cooperates with a tensioning element 15.

4. Tensioning arrangement according to claim 1 wherein the minimum of one further slide rail (8) is constructed so as to assist the minimum of one tensioning rail (10).

5. Tensioning arrangement according to claim 1 wherein the minimum of one further slide rail (8) is constructed in the manner of a slide rail (8) according to one of claims 12 to 21.

6. Control assembly which cooperates with an engine and which comprises a chain (6), a number of wheels (4, 5) and a tensioning arrangement according to claim 1.

7. Control assembly according to claim 6, wherein the chain (6) is looped around the wheels (4, 5).

8. Engine having a housing and a number shafts, said shafts being at least partially mounted in the housing, which comprises a chain (6) cooperating with at least two of the shafts and at least one tensioning arrangement according to claim 1.

9. Engine according to claim 8, wherein at least one of the shafts drives a camshaft.

10. Engine according to claim 1 wherein the housing is formed from aluminum.

11. Engine according to claim 8 wherein the chain (6) is formed from steel.

12. Slide rail for a control assembly (2) of an engine, which is constructed so as to deform as a function of the temperature such that it counteracts thermally-induced tolerance in the control assembly (2).

13. Slide rail according to claim 12 which is to be mounted fixedly relative to the controlled assembly (2).

14. Slide rail according to claim 12 which by virtue of its geometry, material properties and thermal expansion is self-deforming under the influence of temperature such that it counteracts the thermally-induced tolerance in the control assembly (2).

15. Slide rail according to claim 12 which has a sliding surface (18) and is to be attached, via at least one attachment point (16), such that a chain (6) of the control assembly (2) is arranged between the sliding surface (18) and the minimum of one attachment point (16), so that the chain (6) acted upon by the sliding surface (18) is tensioned as a function of the temperature.

16. Slide rail according to claim 12 which is to be attached such that the minimum of one attachment point (16) is arranged on a convex side of the chain (6).

17. Slide rail according to claim 15 wherein the sliding surface (18) is domed.

18. Slide rail according to claim 15 which comprises a section (22) that expands as the temperature increases and extends between the sliding surface (18) and the minimum of one attachment point (16).

19. Slide rail according to claim 12 which is constructed so as to deflect the chain (6) by an adjustment path (s) which is dependent on the temperature (T), wherein a value for the adjustment path (s), at least in a temperature range that prevails during the operation of the engine, decreases at the temperature (T) rises and increases as the temperature (T) falls.

20. Slide rail according to claim 12 which is constructed so as to deflect a chain (6) made of steel.

21. Slide rail according to claim 12 which is to be attached to a housing of the engine, the engine comprising a number of shafts at least partly mounted in the housing, and the control assembly (2) comprising a number of wheels (4, 5) mounted on the shafts, the chain (6) cooperating with these wheels (4, 5).
